(19) United States
(12) Patent Application Publication
(10) Pub. No.: US 2022/0263246 A1
(43) Pub. Date: Aug. 18, 2022

(54) LEAKY WAVEGUIDE ANTENNAS HAVING SPACED-APART RADIATING NODES WITH RESPECTIVE COUPLING RATIOS THAT SUPPORT EFFICIENT RADIATION

(71) Applicant: CommScope Technologies LLC, Hickory, NC (US)

(72) Inventors: Huan Wang, Richardson, TX (US); Michael Brobston, Allen, TX (US)

(21) Appl. No.: 17/626,887

(22) PCT Filed: Jul. 31, 2020
(86) PCT No.: PCT/US2020/044443

§ 371 Date: Jan. 13, 2022

Related U.S. Application Data
(60) Provisional application No. 62/926,049, filed on Oct. 25, 2019.
(60) Provisional application No. 62/898,293, filed on Sep. 10, 2019.

(51) Int. Cl. H01Q 13/20; H01Q 21/00

(52) U.S. Cl. CPC H01Q 13/203; H01Q 21/005

(57) ABSTRACT

An antenna includes an elliptical waveguide having a plurality of length-tapered multi-slot arrays of elongate slots therein at respective spaced-apart locations along a length thereof. The plurality of length-tapered multi-slot arrays of elongate slots can include at least first and second length-tapered multi-slot arrays of elongate slots, which are spaced apart from each other along the length of the elliptical waveguide. The first length-tapered multi-slot array of elongate slots can include: (i) a first elongate slot having a first length and a first width, and (ii) a second elongate slot having a second length less than the first length and a second width that may be greater than the first width.

### FIELD OF THE INVENTION

The present invention relates to antennas and, more particularly, to leaky waveguide antennas that support transmission and reception of radio frequency (RF) signals across their full lengths.

### BACKGROUND

Commercially available leaky feeder antennas, which were originally designed to deliver radio services into tunnels, often utilize coaxial cables, which operate as forward scan antennas at frequencies below about 6 GHz. As illustrated by FIG. 1, a conventional coaxial-type leaky feeder antenna 10 may include: an inner conductor 14b (e.g., copper wire/tube), which is surrounded by a cylindrical dielectric 18 (e.g., foam polyethylene), an outer conductor 14a (e.g., copper foil) having a plurality of equivalent and rectangular-shaped apertures 16 therein, and an electrically insulating outer jacket 12. Unfortunately, signal attenuation due to dissipation losses is typically much higher in coaxial cables relative to waveguides. For example, the signal attenuation in a conventional coaxial cable may be about 0.914 dB/ft, which corresponds to about 18.3 dB/20 ft, whereas the signal attenuation in an otherwise similar elliptical waveguide may be about 0.1 dB/ft, which corresponds to a much lower loss of about 2 dB/20 ft.

Referring now to FIG. 3, perspective (a), bottom (b) and side (c) views are provided of an elliptical waveguide 30, which can support a fundamental transmission mode (i.e., an eTE11 mode) through a frequency band extending from 24 GHz to 26.5 GHz. As illustrated, a single transverse and elongate (e.g., elliptical) slot 32 having a length “Lₛ” and a width “Wₛ” is opened in the waveguide 30, which receives a transmission signal passing lengthwise from entry port 1 (p1) to exit port 2 (p2). The radiation efficiency of this transmission signal is illustrated by FIG. 4, which plots frequency-dependent radiation efficiency over a frequency range from 23 GHz to 27 GHz, for various different slot lengths Lₛ equal to: 0.42λ, 0.46λ, 0.5λ and 0.54λ, and a slot width Wₛ=0.1λ, where the dimension “λ” corresponds to a free space wavelength at 25 GHz, the center frequency. As shown by FIG. 4, the radiation efficiency peak across the illustrated frequency range is inversely dependent on slot length Lₛ, such that each longer slot is associated with an efficiency peak at a lower frequency.

Although not wishing to be bound by any theory, it is anticipated that the width of the slot, Wₛ, be smaller than λ/2 in order to prevent the directivity degradation of co-polarization at the broadside direction (−y in FIG. 3) and the rise of cross-polarization (i.e., x-polarization), as shown by the waveguide 30′ of FIG. 5A, where Lₛ=0.5λ and Wₛ=0.1λ, and as shown by the waveguide 30″ of FIG. 5B, where Lₛ=0.5λ and Wₛ=0.5λ. Moreover, as shown by FIG. 5C, with the slot length Lₛ fixed at 0.5λ, the variation in radiation efficiency as a function of slot width Wₛ, for Wₛ=0.1λ, 0.3λ and 0.5λ, is shown to be more uniform. This demonstrates that slot length Lₛ, not slot width Wₛ, is the primary factor when determining maximum radiation efficiency.

Referring now to the leaky waveguide antenna 60 of FIGS. 6A-6F, multiple elongate slots 62a, 62b, 62c and 62d (i.e., Slots 1-4) of equivalent dimensions within a slot array 62 may be opened at equivalently spaced-apart locations on an “underside” radiating surface of an elliptical waveguide 60, where Lₛ (slot length)=0.67λ, Wₛ (slot width)=0.07λ, and the slot-to-slot spacings g12, g23 and g34 equal 0.25λ. As shown by FIG. 6B, the corresponding radiation efficiencies at 24 GHz, 25 GHz, and 26.5 GHz are 46.96%, 39.9% and 30.2%, respectively, which generally demonstrate insufficiently uniform radiation efficiency across the frequency range from 24-26.5 GHz. And, as illustrated by the corresponding directivity pattern of FIGS. 6C-6F, the radiating beam maxima generally points to θ=−40° relative to the RF transmission signal (TX), with a directivity (at θ=−40°) in a range from about 9.7 dB to about 11 dB across the 24-26.5 GHz frequency band, and with a broadside (−y, θ=−90°) directivity of less than about −6.0 dB across the 24-26.5 GHz frequency band. As will be understood by those skilled in the art, the directivity pattern of FIG. 6C is an example of a “forward scan” pattern because the angle “e” between the beam maximum and the TX signal is −90°<θ<0°, which means the space directly below the leaky waveguide antenna 60 will not be well covered.

### SUMMARY OF THE INVENTION

An antenna according to an embodiment of the invention can include an elliptical waveguide having a plurality of length-tapered multi-slot arrays of elongate slots therein at respective spaced-apart locations along a length thereof. The plurality of length-tapered multi-slot arrays of elongate slots can include at least first and second length-tapered multi-slot arrays of elongate slots, which are spaced apart from each other along the length of the elliptical waveguide. The first length-tapered multi-slot array of elongate slots can include: (i) a first elongate slot having a first length and a first width, and (ii) a second elongate slot having a second length and a second width. According to some embodiments of the invention, the first length is greater than the second length, but the first width is less than the second width. This first length-tapered multi-slot array of elongate slots may further include a third elongate slot having a third length and a third width, with the second length being greater than the third length, but the second width being less than the third width. The second elongate slot may extend between the first elongate slot and the third elongate slot, to thereby provide an array of at least three slots that are length-tapered and width-tapered in an inverse manner. According to further embodiments of the invention, a spacing between a center of the third elongate slot and a center of the second elongate slot may be greater than a spacing between the center of the second elongate slot and a center of the first elongate slot. Nonetheless, the centers of the first, second and third elongate slots may be collinear and may even be aligned with a longitudinal axis of the elliptical waveguide, in some embodiments of the invention.

According to still further embodiments of the invention, the first, second and third elongate slots and the spacings and orientation therebetween are collectively configured (e.g., dimensioned) to support first, second and third radio frequency (RF) radiation (e.g., broadside radiation) from the first, second and third elongate slots, respectively, with corresponding first, second and third radiation output phases (ψ1, ψ2 and ψ3) that deviate from each other by no more than about 90°, and preferably even less than about 50°, in response to application of an RF transmission signal adjacent a first end of the elliptical waveguide.

According to further embodiments of the invention, an antenna is provided as an elongate waveguide having at least one length and width-tapered array of spaced-apart elongate slots therein. This at least one length-tapered and width-tapered array of elongate slots can include a first array of length-tapered and width-tapered elongate slots. This first array may include: (i) a first elongate slot having a first length and a first width, and (ii) a second elongate slot having a second length less than the first length and a second width greater than the first width. This first array may further include a third elongate slot having a third length less than the second length and a third width greater than the second width. The second elongate slot extends between the third elongate slot and the first elongate slot, so that the lengths of the slots are inversely tapered relative to the widths of the slots. Advantageously, the first, second and third elongate slots and the spacings therebetween may be collectively configured to support first, second and third radio frequency (RF) radiation from the first, second and third elongate slots, respectively, with corresponding first, second and third radiation output phases that deviate from each other by no more than about 50°, in response to application of a RF transmission signal adjacent a first end of the waveguide.

According to additional embodiments of the invention, an antenna is provided as a waveguide having a plurality of length and width-tapered arrays of slots therein. These tapered arrays of slots are disposed at respective spaced-apart locations along a full length of the waveguide. A waveguide tail is also provided at a distal end of the waveguide, to support efficient radiation therefrom in a manner similar to the radiation function provided by each of the length and width-tapered arrays of slots distributed along the length of the waveguide. According to some of these embodiments of the invention, the plurality of length and width-tapered arrays of slots are aligned to a longitudinal axis of the waveguide. In addition, the centers of the slots in the arrays can be collinear and aligned to a first side of the waveguide. The waveguide tail may also have a primary and concave-shaped radiation surface thereon, and at least a portion of the concave-shaped radiation surface can face the same direction as the first side of the waveguide. The waveguide tail may also have an opposing convex surface thereon, and at least a portion of the convex surface may face an opposite direction relative to the first side of the waveguide. In some further embodiments of the invention, the waveguide may include a corrugated copper waveguide core, with an elliptical cross-section.

According to still further embodiments of the invention, an antenna is provided as an elongate waveguide having N spaced-apart radio frequency (RF) radiating “leaky” nodes distributed along a length thereof, in an increasing numeric sequence from a proximal end of the waveguide to a distal end of the waveguide. The waveguide is configured so that a coupling ratio (C_{N-1}) associated with an N−1th radiating node is within 10% of L_{N}C_{N}/(1+L_{N}C_{N}), where C_{N} is the coupling ratio associated with the Nth radiating node, L_{N} is the loss factor associated with a segment of the elongate waveguide extending between the N−1th radiating node and the Nth radiating node, and N is a positive integer greater than one. This coupling ratio C_{N} is equivalent to a ratio of the RF power radiated from the Nth radiating node relative to the RF power incident the Nth radiating node, when the elongate waveguide is energized to transfer an RF transmission signal from the N−1th radiating node to the Nth radiating node. In addition, the loss factor L_{N} is equivalent to a ratio of the RF power incident the Nth radiating node relative to the RF power incident the segment of the elongate waveguide extending between the N−1th and Nth radiating nodes, when the elongate waveguide is energized to transfer the RF transmission signal from the N−1th radiating node to the Nth radiating node. This Nth radiating node may extend immediately adjacent a distal end of the elongate waveguide. Preferably, to achieve a high level of radiating efficiency across a full length of the waveguide, the coupling ratio C_{N} associated with this Nth radiating node is in a range from 0.9 to 1.0. The waveguide may also be configured so that a coupling ratio (C_{N-2}) associated with an N−2th radiating node is within 10% of L_{N-1} C_{N-1}/(1+L_{N-1}C_{N-1}), where C_{N-1} is the coupling ratio associated with the N−1th radiating node, and L_{N-1} is the loss factor associated with a segment of the elongate waveguide extending between the N−2th radiating node and the N−1th radiating node. In some aspects of these embodiments, the unequal coupling ratios associated with a plurality of radiating nodes may be achieved using a plurality of length-tapered multi-slot arrays of elongate slots having different dimensions relative to each other.

According to additional embodiments of the invention, an antenna is provided as an elongate waveguide having at least first and second spaced-apart radio frequency (RF) radiating nodes distributed along a length thereof in numeric sequence. This waveguide is configured so that a coupling ratio (C₁) associated with the first radiating node is within 20% of L₂C₂/(1+L₂C₂), where C₂ is the coupling ratio associated with the second radiating node, and L₂ is the loss factor associated with a segment of the elongate waveguide extending between the first and second radiating nodes.

According to still further embodiments of the invention, an antenna is provided as an elongate waveguide having N spaced-apart radio frequency (RF) radiating nodes X₁ through X_{N}, which are distributed along a length thereof in numerical order, with the first node X₁ being the node closest to an RF transmission source. The waveguide is configured so that a coupling ratio (C_{N-1}) associated with an X_{N-1} radiating node is within 10% of L_{N}C_{N}/(1+L_{N}C_{N}), where C_{N} is the coupling ratio associated with radiating node X_{N}, L_{N} is the loss factor associated with a segment of the elongate waveguide extending between radiating node X_{N-1} and radiating node X_{N}, and N is a positive integer greater than one. This coupling ratio C_{N} is equivalent to a ratio of the RF power radiated from radiating node X_{N} relative to the RF power incident at radiating node X_{N}, when the elongate waveguide is energized to transfer an RF transmission signal from radiating node X_{N-1} to radiating node X_{N}. In addition, the loss factor L_{N} is equivalent to a ratio of the RF power incident at radiating node X_{N} relative to the RF power incident the segment of the elongate waveguide extending between radiating nodes X_{N-1} and X_{N}, when the elongate waveguide is energized to transfer the RF transmission signal from radiating node X_{N-1} to radiating node X_{N}.

### BRIEF DESCRIPTION OF THE DRAWINGS

FIG. 1 is a perspective view of a leaky coaxial cable for frequency bands below 6 GHz, according to the prior art.

FIG. 2 is a simplified schematic diagram of a 100 ft waveguide having 5 equally spaced-apart nodes of leaky antennas therein.

FIG. 3 illustrates a perspective view (a), a bottom view (b) and a side view (c) of corresponding portions of an elliptical leaky waveguide having a single elongate slot therein according to the prior art, where the dimension “A” corresponds to a free space wavelength at 25 GHz.

FIG. 4 is a graph that illustrates radiation efficiency (radiated power/incident power) of the waveguide of FIG. 3 versus frequency (e.g., 23-27 GHz) at various slot lengths Ls of 0.42λ, 0.46λ, 0.5λ and 0.54λ, for a slot width Ws of 0.1λ.

FIG. 5A illustrates a directivity pattern for the waveguide of FIG. 3 having a single slot with length Ls equal to 0.5λ and width Ws of 0.1λ, @ 24-26.5 GHz.

FIG. 5B illustrates a directivity pattern for the waveguide of FIG. 3 having a single slot with length Ls equal to 0.5λ and width Ws of 0.5λ, @ 24-26.5 GHz.

FIG. 5C is a graph that illustrates radiation efficiency (radiated power/incident power) of the waveguide of FIG. 3 versus frequency (23-27 GHz) at various slot widths Ws of 0.1λ, 0.3λ and 0.5λ, for a slot length Ls of 0.5λ.

FIG. 6A illustrates a perspective view (a) and a bottom view (b) of corresponding portions of an elliptical leaky waveguide antenna having a quad-arrangement of identical and equally spaced-apart elliptical slots therein according to the prior art, where the dimension “A” corresponds to a free space wavelength at 25 GHz, Ls=0.67λ, Ws=0.07λ, and g12=g23=g34=0.25λ, where g12, g23, and g34 are the inter-slot spacing distances.

FIG. 6B is a graph that illustrates radiation efficiency (radiated power/incident power) of the leaky waveguide antenna of FIG. 6A versus frequency, across a frequency range from 24 GHz to 26.5 GHz.

FIG. 6C illustrates a directivity pattern for the waveguide of FIG. 6A, which illustrates a beam maxima pointing to θ=−40° with a directivity (at θ=−40°) in a range from about 9.7 dB to about 11 dB across the 24-26.5 GHz frequency band, and with a broadside directivity (−y, θ=−90) directivity of less than about −6.0 dB across the 24-26.5 GHz frequency band.

FIG. 6D is a graph that illustrates a directivity pattern for the waveguide of FIG. 6A, which illustrates a beam maxima pointing to θ=−40° with a directivity (at θ=−40°) in a range from about 9.7 dB to about 11 dB across the 24-26.5 GHz frequency band, and with a broadside directivity (−y, θ=−90°) directivity of less than about −6.0 dB across the 24-26.5 GHz frequency band.

FIG. 6E is an enlarged view of a first portion of the graph of FIG. 6D, which illustrates a beam maxima pointing to θ=−40° with a directivity (at θ=−40°) in a range from about 9.7 dB to about 11 dB across the 24-26.5 GHz frequency band.

FIG. 6F is an enlarged view of a second portion of the graph of FIG. 6D, which illustrates a broadside directivity (−y, θ=−90°) directivity of less than about −6.0 dB across the 24-26.5 GHz frequency band.

FIG. 7A illustrates a perspective view (a) and bottom view (b) of an elliptical waveguide segment having a tapered multi-slot array therein, according to an embodiment of the invention.

FIG. 7B is a graph that illustrates radiation efficiency of the waveguide segment of FIG. 7A when the entry port p1 is excited with an RF transmission signal (TX) across a frequency range from 24 to 26.5 GHz, according to an embodiment of the invention.

FIG. 7C is an electrical schematic of a lossy filter, which approximates operation of the waveguide segment of FIG. 7A, according to an embodiment of the invention.

FIG. 7D is a graph of output phase (ψ) versus frequency for each of the four tapered slots in the multi-slot array of FIG. 7A, across a frequency range from 24-26.5 GHz.

FIG. 7E is a graph of output phase (ψ) versus frequency for each of the four slots in the conventional multi-slot array of FIG. 6A, across a frequency range from 24-26.5 GHz.

FIGS. 8A and 8C-8D are directivity patterns for the waveguide segment of FIG. 7A, which illustrates a beam maximum pointing to θ=−90° (−y axis, broadside) with a directivity of greater than 7.23 dB throughout the frequency range from 24 GHz to 26.5 GHz.

FIGS. 8B and 8F-8G are directivity patterns for the waveguide segment of FIG. 7A for an anti-TX signal, which illustrates a directivity of less than −0.73 dB at θ=−90° (broadside) throughout the frequency range from 24 GHz to 26.5 GHz.

FIG. 8E is a graph that illustrates how a radiation efficiency of the waveguide segment of FIG. 7A under anti-TX mode is, on average, 4% lower when compared to the radiation efficiency illustrated by FIG. 7B.

FIG. 9A is a graph that illustrates power flux in the waveguide segment of FIG. 7A when a received RF signal (RX) is incident from broadside, and highlights power transmitted to the TX end (left) and power transmitted away from the TX end (right). At 25 GHz, the power transmitted to the TX end is 4 dB+ higher than the power transmitted away from the TX end.

FIG. 9B is a schematic diagram that illustrates how, during a receiving (RX) mode, the received signal does not interfere with a TX signal, and does not radiate to broadside from the other slot arrays, within an elliptical waveguide, according to an embodiment of the invention.

FIG. 10A illustrates a pair of directivity patterns in the yz-plane and the xy-plane for a “scorpion” tail, which can be used to efficiently terminate a distal end of a leaky waveguide antenna, such as the elliptical waveguide antenna of FIG. 7A and the waveguide antenna of FIG. 9B.

FIG. 10B is a graph that illustrates an almost perfect radiation efficiency for the tail “radiator” of FIG. 10A, across a frequency range from 24 GHz to 26.5 GHz.

FIG. 11A is a schematic view of a leaky waveguide antenna having two (2) slots of unequal length (0.52λ and 0.43λ) but equivalent width (0.25λ), according to an embodiment of the invention.

FIG. 11B is a graph that illustrates a generally uniform radiation efficiency of about 38%, across a frequency range from 24 GHz to 26.5 GHz, for the leaky waveguide antenna of FIG. 11A.

FIG. 12A illustrates a perspective view of an elliptical waveguide antenna segment having first and second slots therein on respective first and second opposing sides thereof, according to an embodiment of the invention.

FIG. 12B illustrates a directivity pattern for the waveguide antenna segment of FIG. 12A.

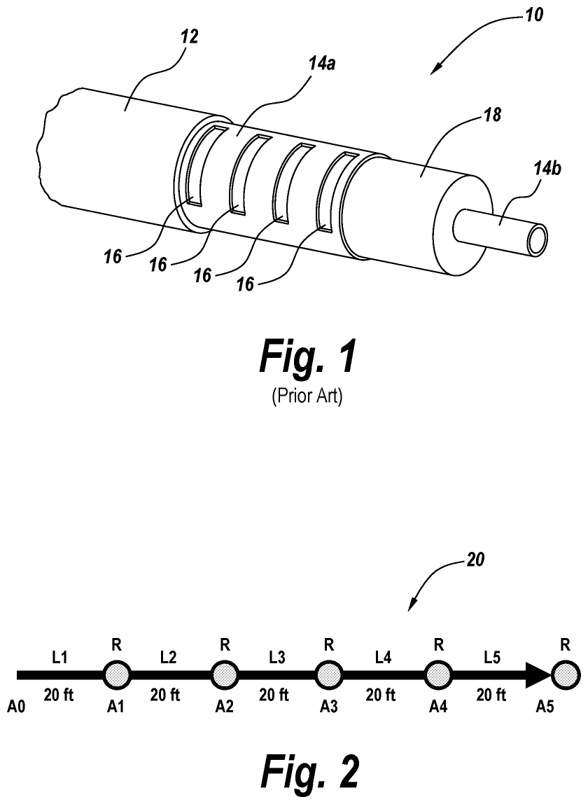

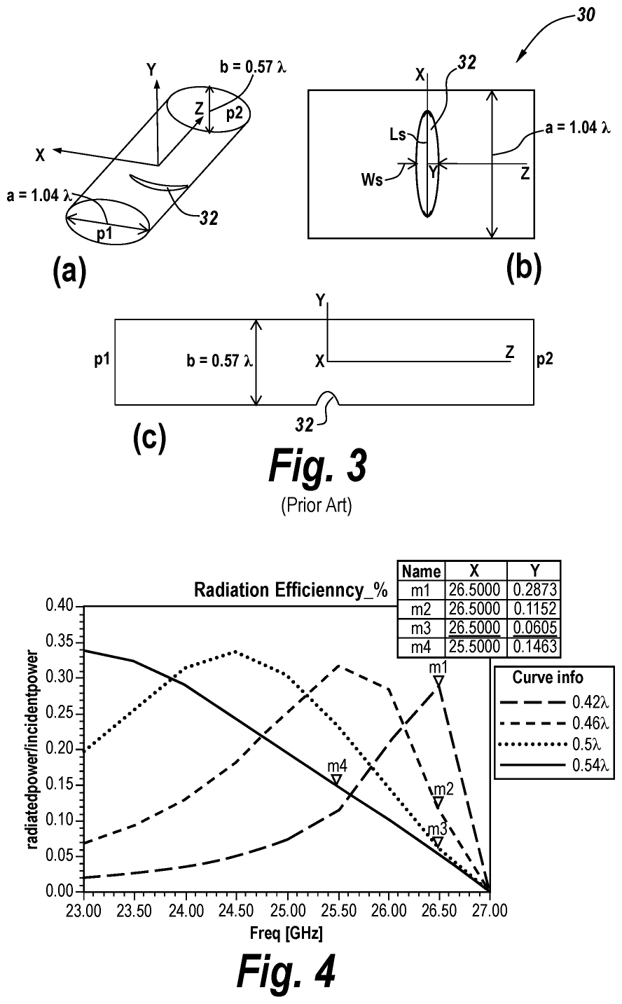

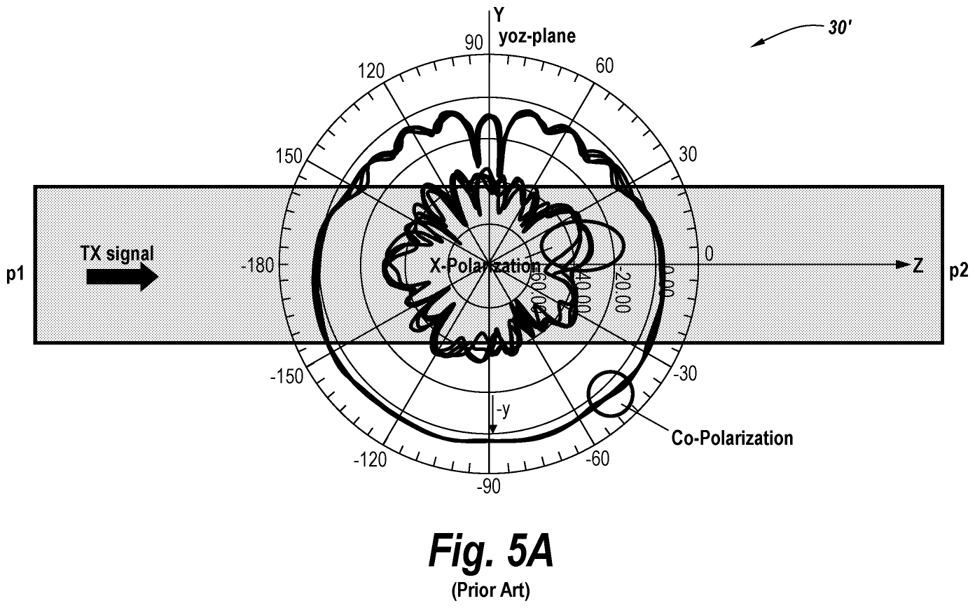

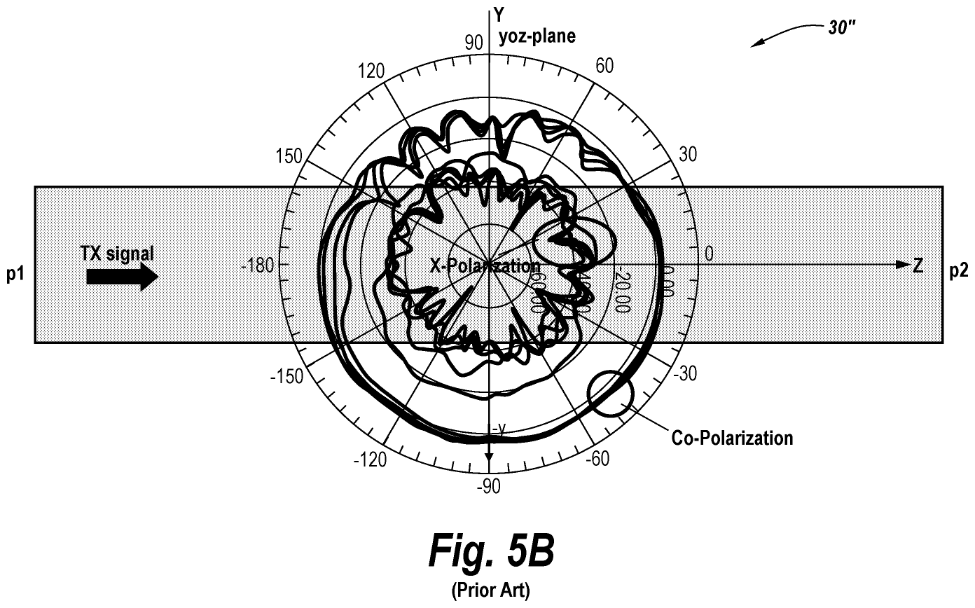

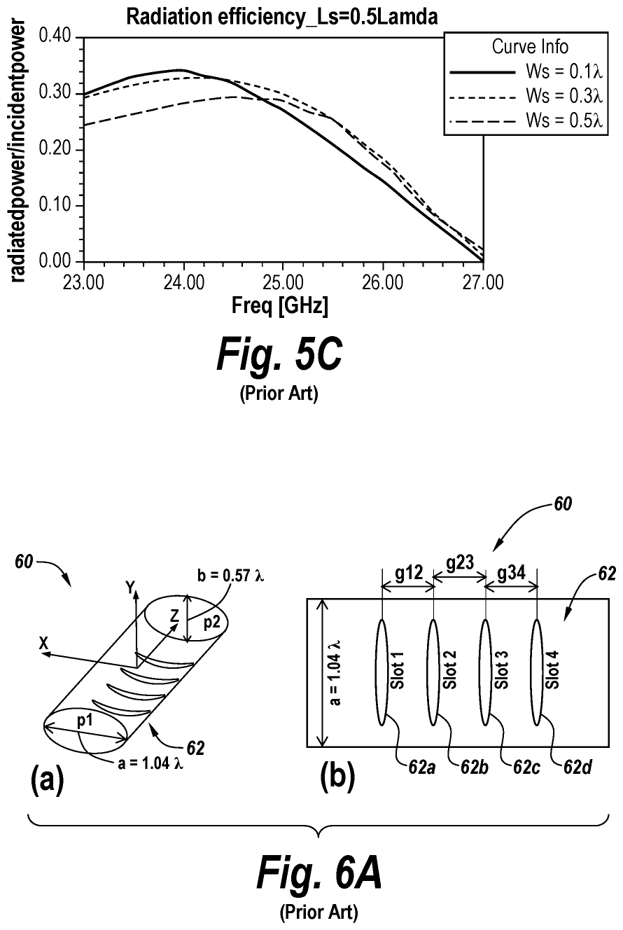

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The power distribution along a leaky waveguide 20 may be as illustrated by FIG. 2, with A₀ being the radio frequency (RF) input source power (100%) and A₁−Aₙ being the percentage of the RF power available at each radiating node, where N is the node number in numerical sequence from the proximal end (adjacent the RF source) to the distal end of the waveguide 20. The power radiated from each individual node A1-A5 is represented by R_{N}, and the loss associated with the waveguide sections between nodes is represented by L_{N}. The ratio of the power radiated from each node relative to the power incident upon that node can be represented by a coupling ratio, C_{N}. In addition, the required coupling ratio needed to radiate a desired amount of power from each node can be determined using the following derivation, which assumes a waveguide containing five (5) radiating nodes, but is applicable to waveguides containing any number of nodes, and waveguides containing unequally spaced apart nodes.

Assuming the input radio frequency (RF) power injected into the input port A₀ of the waveguide 20 is represented as P, then the power R₁ radiated from the first node is a function of the first section waveguide loss factor, L₁, and the first radiator coupling ratio, C₁, and is given by the following equation:

R₁−P·L₁·C₁

Likewise, the power R₂−R₅ radiated from the 2^{nd} through the 5^{th} nodes can be given by the following equations:

R₂=P·L₁·(1−C₁)·L₂·C₂

R₉=P·L₁·(1−C₁)·L₂·(1−C₂)·L₈·C₈

R₄=P·L₁·(1−C₁)·L₂·(1−C₂)·L₅·(1−C₅)·L₄·C₄

R₀=P·L₁·(1−C₁)·L₂·(1−C₂)·L₀·(1−C₂)·L₄·(1−C₄)·L₀·C₀

If these equations are converted to represent the power radiated from each node as a ratio of the injected power, then they become:

$$\frac{{R}_{1}}{P} = {L}_{1} \cdot {C}_{1} \\ \frac{{R}_{2}}{P} = {L}_{1} \cdot ( 1 - {C}_{1} ) \cdot {L}_{2} \cdot {C}_{2} \\ \frac{{R}_{3}}{P} = {L}_{1} \cdot ( 1 - {C}_{1} ) \cdot {L}_{2} \cdot ( 1 - {C}_{2} ) \cdot {L}_{3} \cdot {C}_{3} \\ \frac{{R}_{4}}{P} = {L}_{1} \cdot ( 1 - {C}_{1} ) \cdot {L}_{2} \cdot ( 1 - {C}_{2} ) \cdot {L}_{3} \cdot ( 1 - {C}_{3} ) \cdot {L}_{4} \cdot {C}_{4} \\ \frac{{R}_{5}}{P} = {L}_{1} \cdot ( 1 - {C}_{1} ) \cdot {L}_{2} \cdot ( 1 - {C}_{2} ) \cdot {L}_{3} \cdot ( 1 - {C}_{3} ) \cdot {L}_{4} \cdot ( 1 - {C}_{4} ) \cdot {L}_{5} \cdot {C}_{5}$$

If the waveguide 20 is designed so that an equal amount of power is to be radiated from each of the five (5) nodes, then all of the R/P ratios can be treated ideally as equal. Nonetheless, in alternative waveguide designs, the R/P ratios may be configured to be within about 10%-20% of each other. To achieve this goal of equivalency, the required coupling ratios associated with each intermediate node can be determined by using the above equations to solve for C_{N}, where:

$${C}_{1} = \frac{{L}_{2} \cdot {C}_{2}}{1 + {L}_{2} \cdot {C}_{2}} \\ {C}_{2} = \frac{{L}_{3} \cdot {C}_{3}}{1 + {L}_{x} \cdot {C}_{x}} \\ {C}_{3} = \frac{{L}_{4} \cdot {C}_{4}}{1 + {L}_{\text{?}} \cdot {C}_{\text{?}}} \\ {C}_{4} = \frac{{L}_{5} \cdot {C}_{5}}{1 + {L}_{x} \cdot {C}_{x}} \\ \text{?} \text{indicates text missing or illegible when filed}$$

Moreover, because it can be assumed that all remaining power incident at the last node should be radiated, then the final coupling ratio, C₅, can be set to 100% (i.e., C₅=1), or at least greater than about 85-90% to achieve a high level of overall radiation efficiency. This assumption means that the intermediate coupling ratios will be dependent upon the waveguide loss factors between each node. Thus, for this five (5) node example of FIG. 2, it can be assumed that all the nodes should be equally spaced from each other, but other spacings are also possible based on the specific requirements of the intended coverage area. If it is assumed that the waveguide loss is 0.1 dB/ft and the nodes are equally spaced at intervals of 20 feet, then the losses between each of the nodes is 2 dB, which suggests a linear loss factor of 0.631 (i.e., L_{N}=0.631, where 63.1% of the segment incident power is retained for the next node, but 36.9% is lost in the preceding waveguide segment). By solving the above equations for Lₙ=0.631 and based on a desired C₅=1, the coupling ratios for nodes 1 through 4 are calculated as follows so that equal radiation may be provided from each node:

C₄=0.386

C₃=0.196

C₂=0.110

C₁=0.065

Accordingly, as described hereinabove with respect to FIG. 2, an antenna may be provided as an elongate waveguide 20 having N spaced-apart radio frequency (RF) radiating “leaky” nodes A1-A5 distributed along a length thereof, in an increasing numeric sequence from a proximal end of the waveguide 20 (at A0) to a distal end of the waveguide 20 (at A5). The waveguide 20 is configured so that a coupling ratio (C_{N-1}) associated with an N−1th radiating node (e.g., A4) is within 10% of L_{N}C_{N}/(1+L_{N}C_{N}), where C_{N} is the coupling ratio associated with the Nth radiating node (e.g., A5), L_{N} is the loss factor associated with a segment of the elongate waveguide extending between the N−1th radiating node and the Nth radiating node, and N is a positive integer greater than one. This coupling ratio C_{N} is equivalent to a ratio of the RF power radiated from the Nth radiating node relative to the RF power incident the Nth radiating node, when the elongate waveguide 20 is energized to transfer an RF transmission signal from the N−1th radiating node to the Nth radiating node. In addition, the loss factor L_{N} is equivalent to a ratio of the RF power incident the Nth radiating node relative to the RF power incident the segment of the elongate waveguide extending between the N−1th and Nth radiating nodes, when the elongate waveguide is energized to transfer the RF transmission signal from the N−1th radiating node to the Nth radiating node. This Nth radiating node may extend immediately adjacent a distal end of the elongate waveguide (e.g., A_{N}=A5). Preferably, to achieve a high level of radiating efficiency across a full length of the waveguide, the coupling ratio C_{N} associated with this Nth radiating node is in a range from about 0.85 to 1.0. The waveguide may also be configured so that a coupling ratio (C_{N-2}) associated with an N−2th radiating node is within 10% of L_{N-1} C_{N-1}/(1+L_{N-1}C_{N-1}), where C_{N-1} is the coupling ratio associated with the N−1th radiating node, and L_{N-1} is the loss factor associated with a segment of the elongate waveguide extending between the N−2th radiating node and the N−1th radiating node.

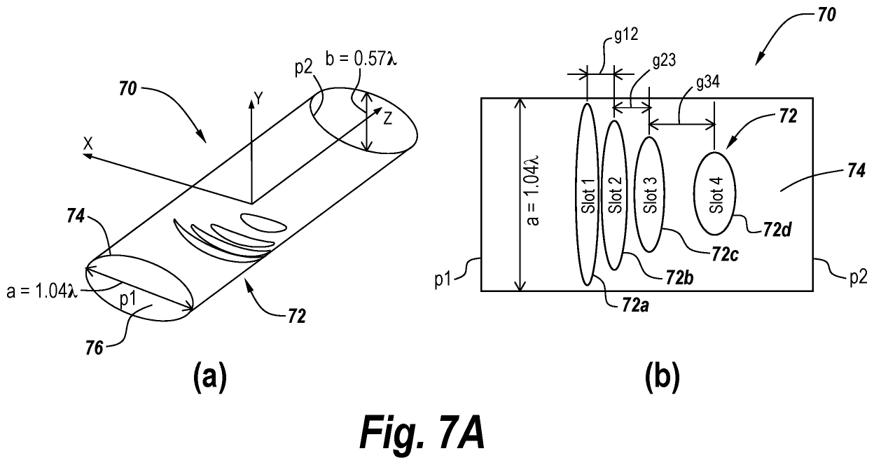

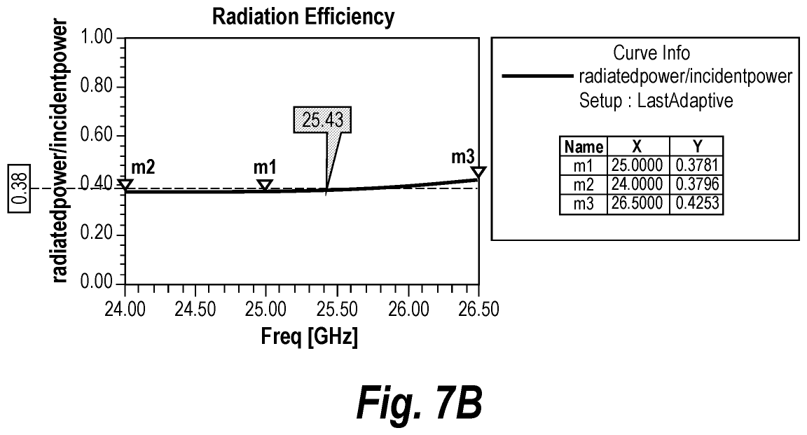

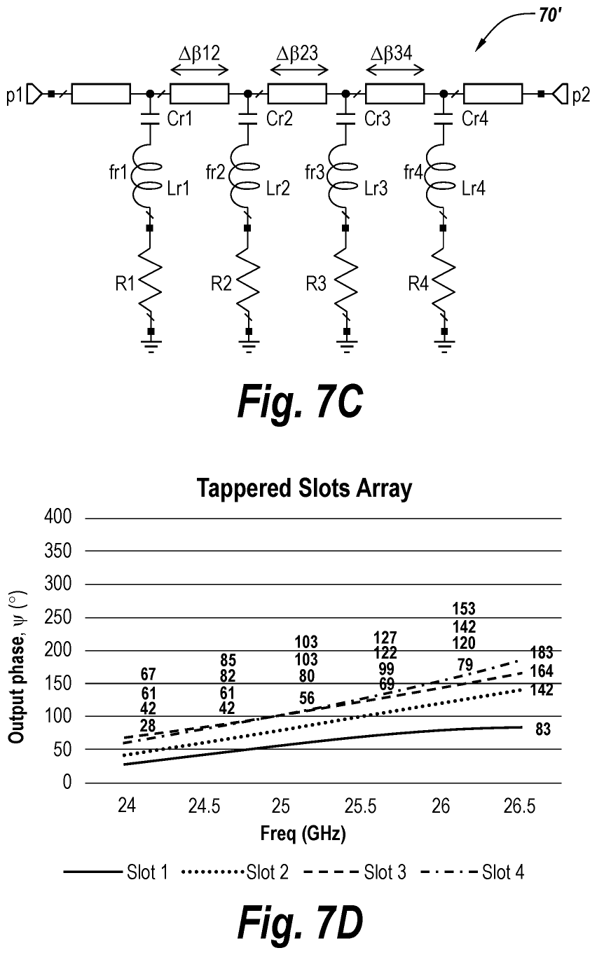

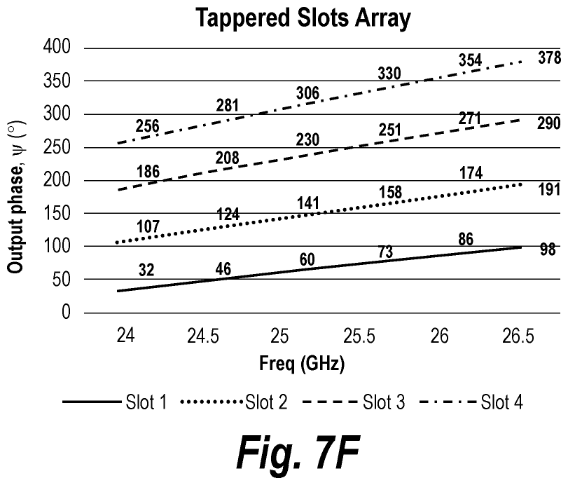

Referring now to FIGS. 7A-7C, an elliptical waveguide 70 having a multi-slot array 72 of tapered slots therein is illustrated as including four elongate (e.g., elliptical, rectangular) slots, which may be machined as grooves or holes/openings into an outer surface of the waveguide 70, and a surrounding electrically insulating outer jacket (e.g., polyethylene jacket), not shown. These four slots are identified as slot 1 (72a), slot 2 (72b), slot 3 (72c) and slot 4 (72d), which have tapered lengths and possibly tapered widths relative to each other, such that the lengths of the four slots decrease in the following order: slot 1>slot 2>slot 3>slot 4, whereas the widths of the four slots may (or may not) increase in the following order: slot 1≤slot 2≤slot 3≤slot 4.

As shown, the elliptical waveguide 70 is illustrated as having an RF transmission signal entry port “p1” for coupling RF energy to an electrically conductive waveguide 76, a RF transmission signal exit port “p2”, a width “a” equivalent to 1.04λ and a height/thickness ‘b″ equivalent to 0.57λ, where the dimension “λ”, as used herein, corresponds to a free space wavelength at 25 GHz. In some embodiments of the invention, the electrically conductive waveguide 76 may be configured as a flexible corrugated and hollow copper core of predetermined length having an elliptical cross-section, and may be manufactured to great lengths (e.g., >100 ft), before being machined (with tapered slot arrays) and shipped on industrial spools for field installation.

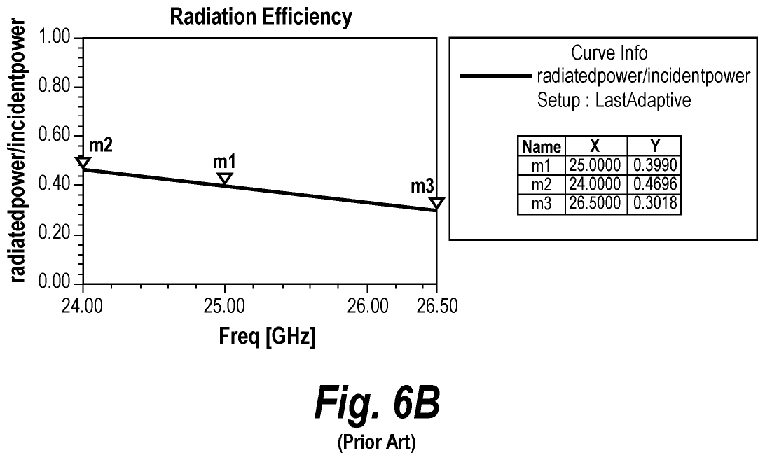

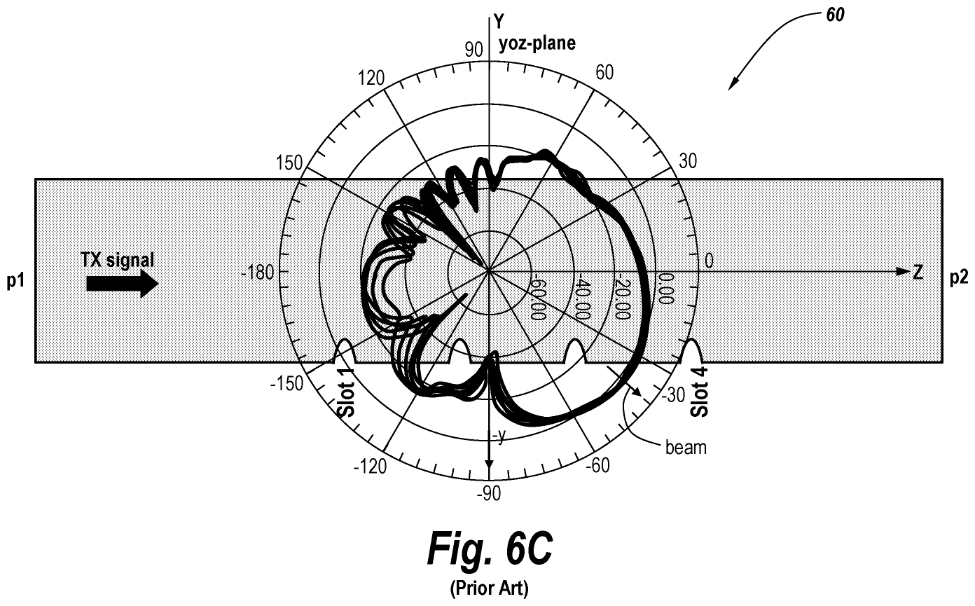

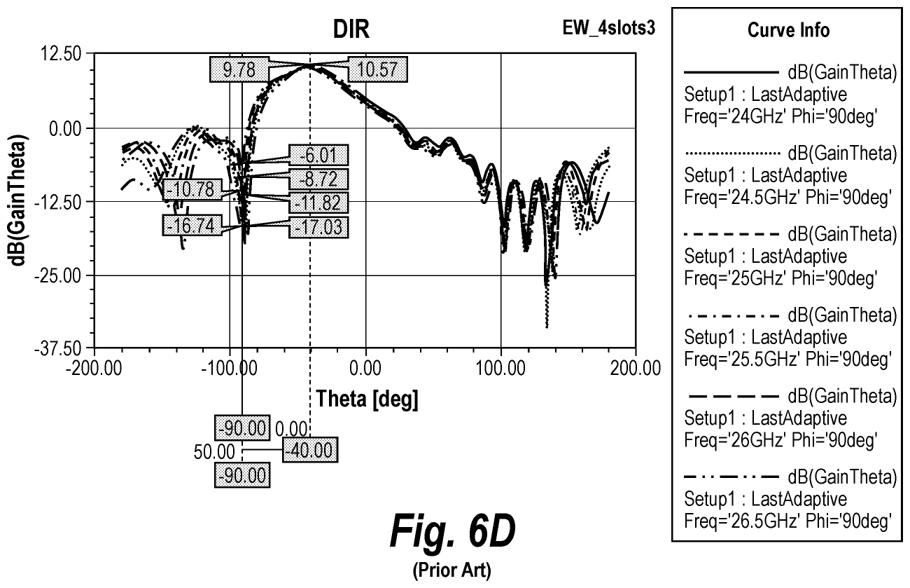

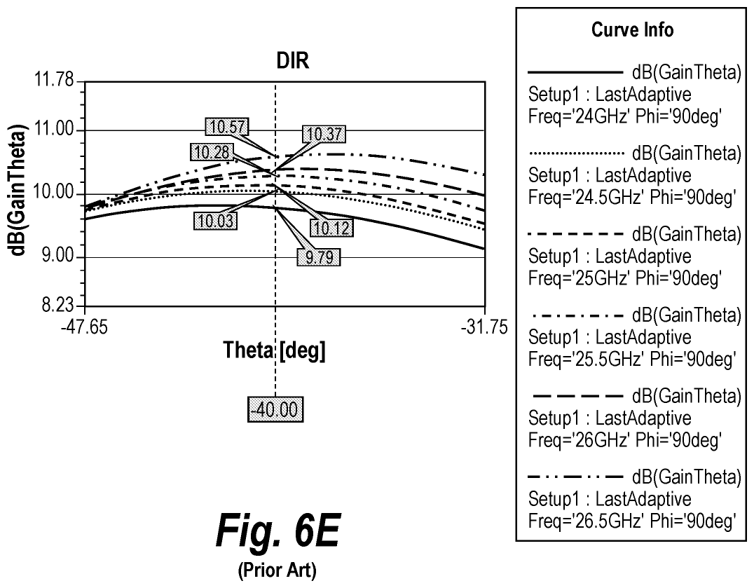

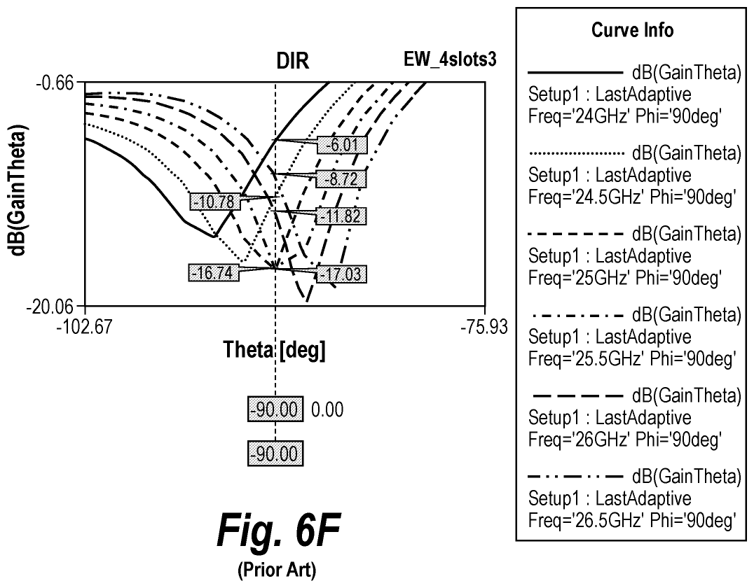

In addition, the interslot spacings between the first and second slots (72a-72b), the second and third slots (72b-72c), and the third and fourth slots (72c-72d) are respectively identified as g12, g23 and g34, where g34>g23>g12. As illustrated by FIG. 7B, highly uniform radiation efficiencies over a frequency band from 24-26.5 GHz can be achieved for the waveguide 70 of FIG. 7A, for the case where slots 1-4 have respective tapered lengths of Ls1=0.92λ, Ls2=0.75λ, Ls3=0.58λ and Ls4=0.42λ, as measured across the major axis of the elongate (e.g., elliptical) slots, g12=0.13λ, g23=0.17λ and g34=0.32λ, and: the width of slot 1 (Ws1) width of slot 2 (Ws2) width of slot 3 (Ws3) width of slot 4 (Ws4), where Ws1=0.11λ, Ws2=0.12λ, Ws3=0.14λ, and Ws1=0.2λ. Compared to the radiation efficiency results of FIG. 6B, the length and width-tapered slot array 72 within the waveguide 70 of FIG. 7A yields a more uniform radiation efficiency of 37.81% to 42.53% across the frequency band of 24-26.5 GHz, relative to the significantly less uniform radiation efficiency range of 46.96% to 30.18% associated with the quad-arrangement of identical and equally spaced-apart elliptical slots 62a-62d of FIG. 6A.

Although not wishing to be bound by any theory, it is believed that the varying shapes, spacing and sizing of the slots 72a, 72b, 72c and 72d illustrated by FIG. 7A support different resonant frequencies, and that cascading these slots in a length/width tapered array 72 can yield a more uniform wideband response. In contrast, it is believed that the relatively poor coverage evidenced by the “forward scan” pattern of FIG. 6C is due the fact that each proceeding slot has a progressive phase lead current excitation relative to the preceding slot, which means the output phase of slot 1 always leads and the output phase of slot 4 always lags by comparison.

The radio frequency (RF) operation of this proposed tapered slot configuration of FIG. 7A may also be modeled by the operation of a multi-stage lossy filter 70′, as shown by FIG. 7C, where fr1, fr2, fr3 and fr4 represent the resonance frequencies of the corresponding slots 72a-72d, where fr1 corresponds to frequency 1 for resonator 1 (comprising inductor Lr1 and capacitor Cr1), fr2 corresponds to frequency 2 for resonator 2 (comprising inductor Lr2 and capacitor Cr2), fr3 corresponds to frequency 3 for resonator 3 (comprising inductor Lr3 and capacitor Cr3) and fr4 corresponds to frequency 4 for resonator 4 (comprising inductor Lr4 and capacitor Cr4). The resistors R2-R4 represent the radiation resistance of the slots 72a-72d, and the delay elements Δβ12, Δβ23 and Δβ34 represent the phase delays caused by the waveguide sections g12, g23 and g34. In addition, if the series LC resonators fr1, fr2, fr3 and fr4 are configured so that fr1<fr2<fr3<fr4, then the “cascade-slot” filter 70′ of FIG. 7C (and antenna 70) can be expected to have a highly uniform radiation response across the frequency band from fr1 to fr4.

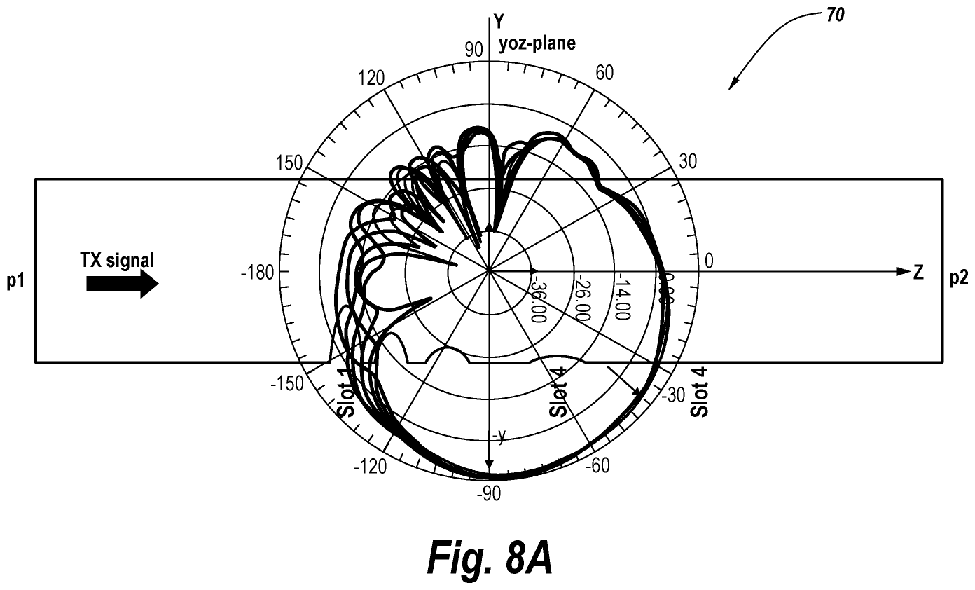

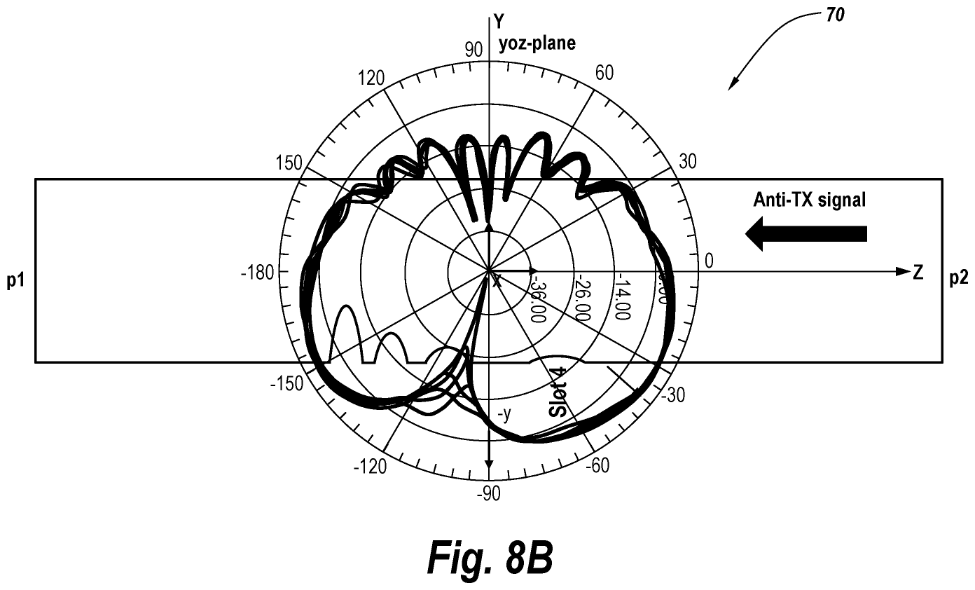

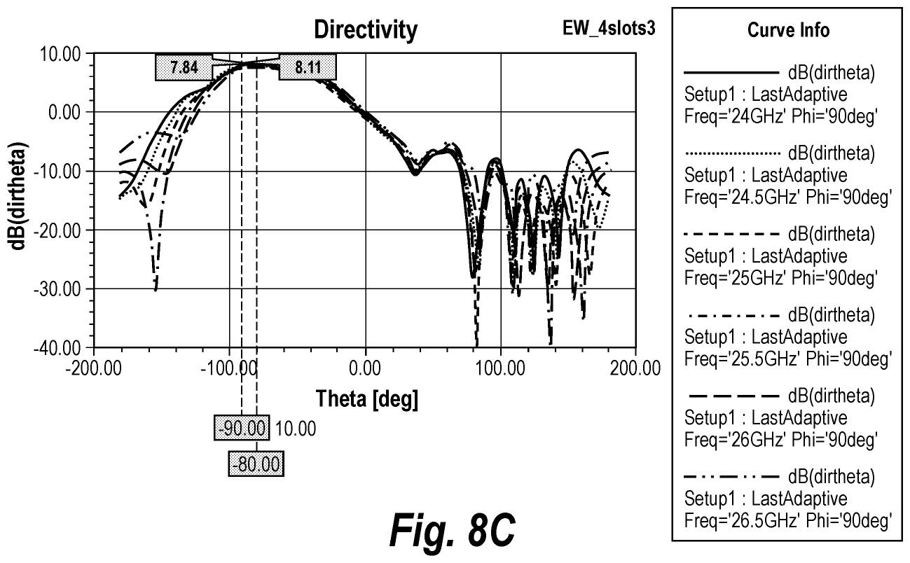

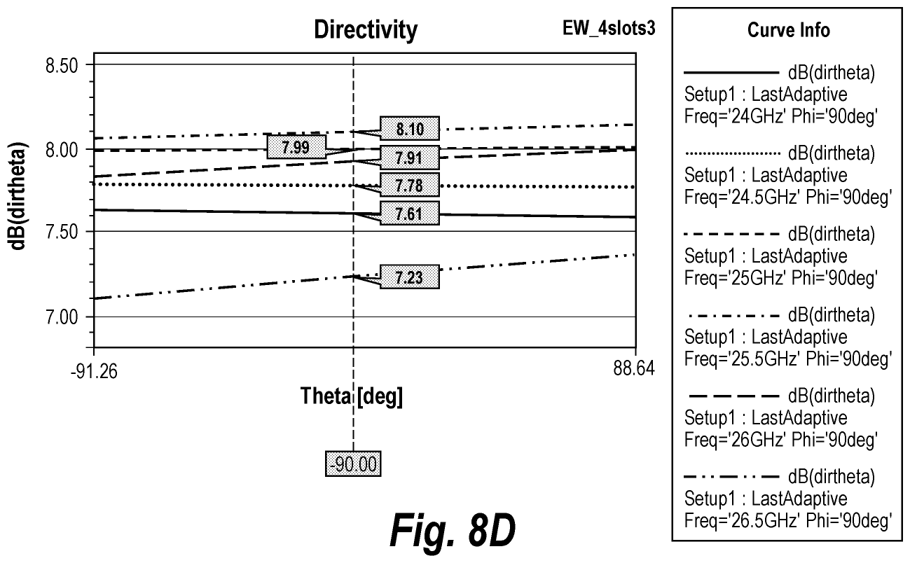

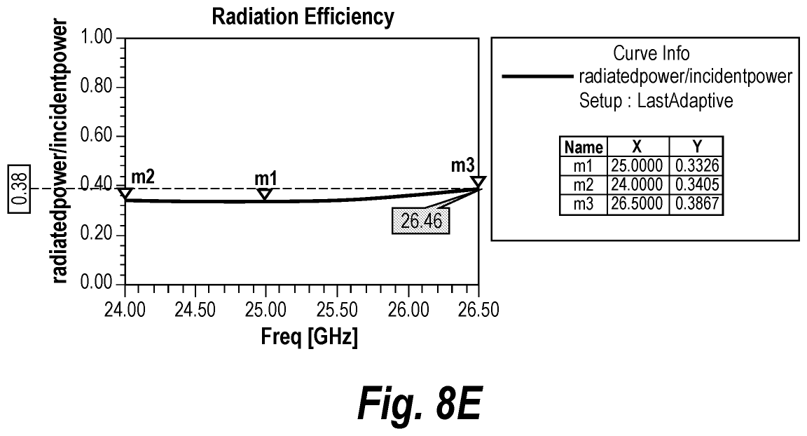

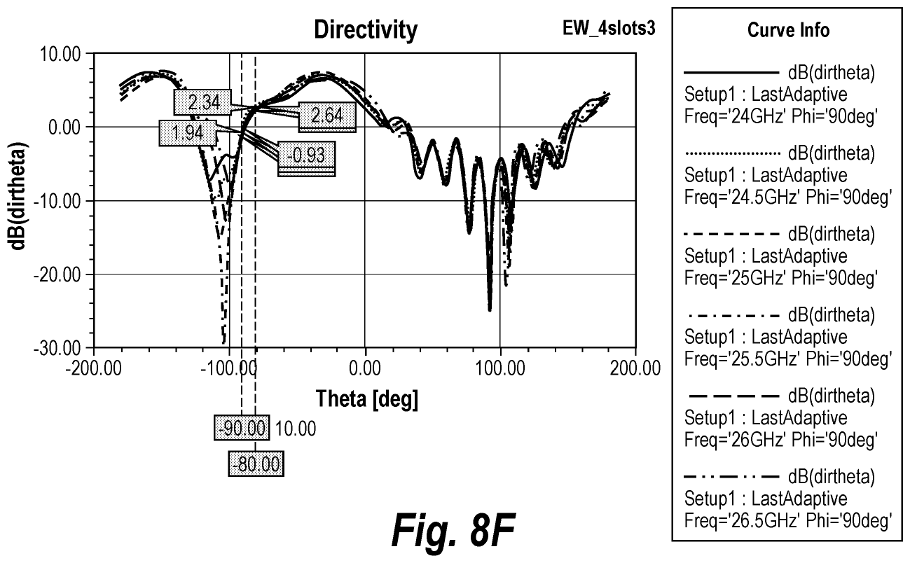

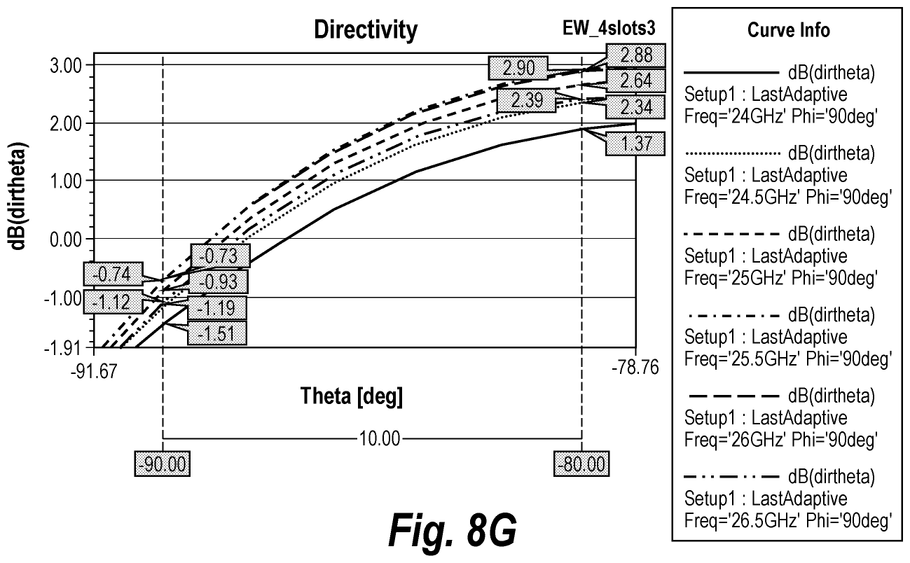

As illustrated by the simulated directivity pattern of FIGS. 8A and 8C-8D for the antenna 70 and slot array 72 of FIG. 7A (having a longitudinal axis extending in the z-direction), a beam maxima is illustrated as pointing to θ=−90° (−y axis, broadside) with a directivity of greater than 7.23 dB throughout the frequency range from 24 GHz to 26.5 GHz, which is a significant improvement over the directivity pattern of FIG. 6C.

Referring again to the waveguide 70 of FIG. 7A, when the entry port p1 is excited by a transmission signal (TX), the slots 72a-72d within the waveguide 70 may generate respective phase delays identified as β1 (for slot 72a), β2 (for slot 72b), β3 (for slot 72c) and β4 (for slot 72d), whereas the inter-slot waveguide sections g12, g23 and g34 may generate phase delays equal to Δ312, Δβ23 and Δβ34, respectively. Accordingly, the output phases ψ1, ψ2, ψ3 and ψ4 of the transmitted radiation at each of the slots 72a-72d can be expressed as:

ψ1=β1;

ψ2=Δβ12+β2;

ψ3=Δβ12+Δβ23+β3; and

ψ4=Δβ12+Δβ23+Δβ34+β4

And, because the slots 72a-72d have tapered lengths (i.e., Ls1>Ls2>Ls3>Ls4), then β1>β2>β3>β4. This suggests that a broadside radiation pattern is fully achievable for the elliptical waveguide antenna 70 of FIG. 7A, if the inter-slot waveguide sections g12, g23 and g34 are designed to achieve the following equivalencies, so that ψ1, ψ2, ψ3 and ψ4 are within 50° of each other (e.g., at 25 GHz):

Δβ12=β1−β2;

Δβ23=β2−β3; and

Δβ34=β3−β4

In contrast, when the exit port p2 is excited by an anti-TX signal, as shown by the directivity pattern of FIG. 8B, the output phases of the tapered slots 72a-72d for the anti-TX signal are as follows:

ψ4=β4;

ψ3=Δβ34+β3;

ψ2=Δβ34+Δβ23+β2; and

ψ1=Δβ34+Δβ23+Δβ12+β1

But, in order to solve these equations to achieve equivalent output phase ψ, the inter-slot delays Δβ12 (i.e., β2−β1), Δβ23 (i.e., β3−β2) and Δβ34 (i.e., β4−β3) must all be negative, which is not possible. Accordingly, as illustrated by FIGS. 8B and 8E-8G, where the directivity is less than −0.73 dB at θ=−90° (broadside) throughout the frequency range from 24 GHz to 26.5 GHz, an anti-TX signal is not capable of generating a significant broadside radiation pattern.

Nonetheless, with respect to the tapered slots 72a-72d of FIG. 7A and as illustrated by the graph of FIG. 7D, the phases ψ1 (slot 1), ψ2 (slot 2), ψ3 (slot 3) and ψ4 (slot 4) span a relatively small range as: 28°, 42°, 67°, and 61° at 24 GHz; 42°, 61°, 85° and 81° at 24.5 GHz; 56°, 80°, 103° and 103° at 25 GHz; 69°, 99°, 122°, and 127° at 25.5 GHz; 79°, 120°, 142°, and 153° at 26 GHz; and 83°, 142°, 164°, and 183° at 26.5 GHz. In contrast, with respect to the uniform slots of 62a-62d of FIG. 6A and as illustrated by the graph of FIG. 7E, the phases ψ1 (slot 1), ψ2 (slot 2), ψ3 (slot 3) and ψ4 (slot 4) are: 32°, 107°, 186°, and 256° at 24 GHz; 46°, 124°, 208°, and 281° at 24.5 GHz; 60°, 141°, 230°, and 306° at 25 GHz; 73°, 158°, 251°, and 330° at 25.5 GHz; 86°, 174°, 271°, and 354° at 26 GHz; and 98°, 191°, 290°, and 378° at 26.5 GHz.

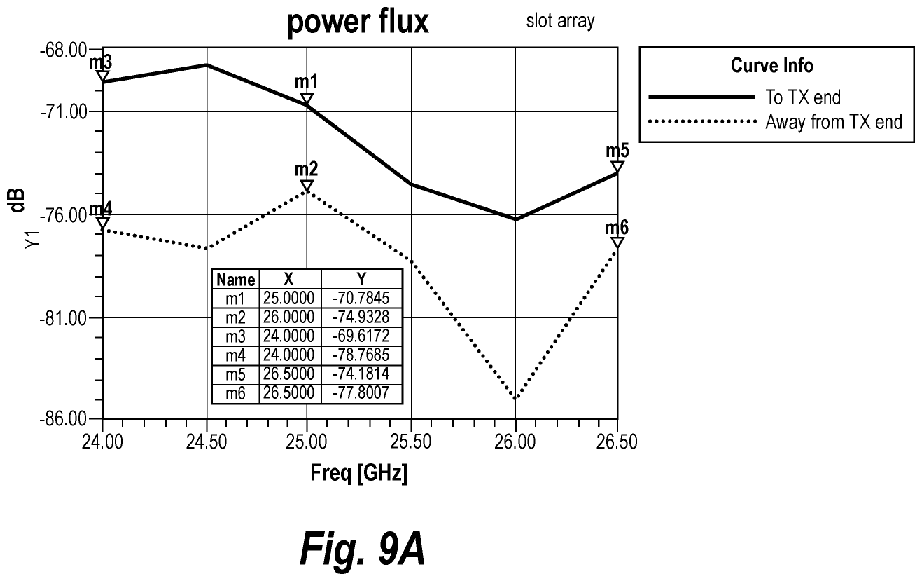

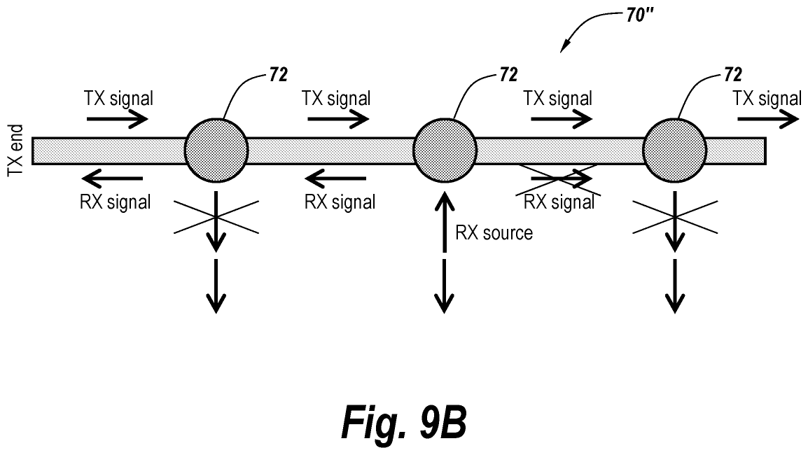

Next, as shown by FIGS. 9A-9B, when an RX source is illuminating a tapered slot array 72 (i.e., 72a, 72b, 72c and 72d) at an intermediate location along a waveguide antenna 70″ and at a center frequency of 25 GHz, the received power transmitted to the TX end is 4 dB+ higher than the power transmitted to the opposite end. This is useful because during an RX mode, the received power does not materially interfere with the TX signal, and does not radiate to the broadside from the other slot arrays, as shown schematically by FIG. 9B. Moreover, although not explicitly shown by FIG. 9B, a distal end of the waveguide antenna 70″ (i.e., farthest from the TX end) may be terminated with a tapered slot array 72, according to some embodiments of the invention. However, other techniques, such as resistive load termination (not shown), may also be used to efficiently terminate a waveguide antenna and absorb residual power, according to other embodiments of the invention.

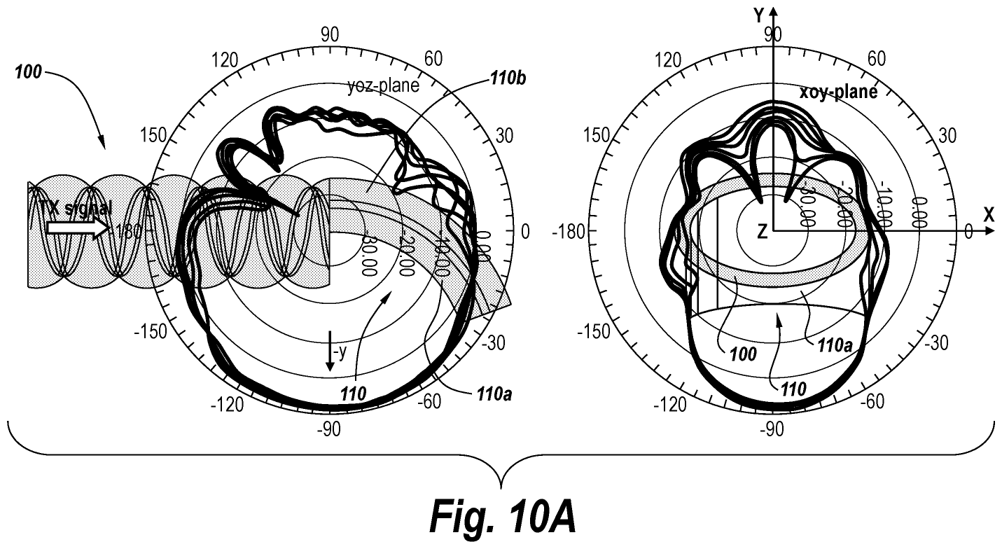

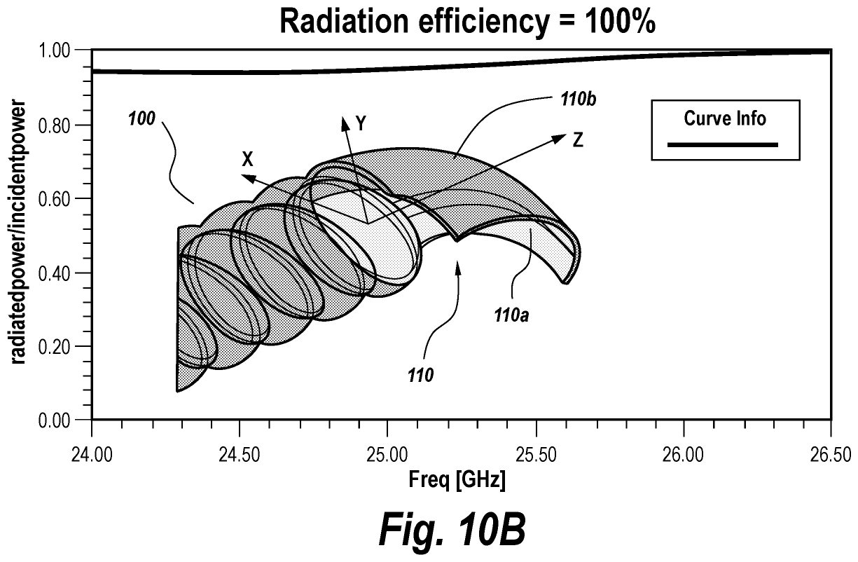

For example, FIG. 10A illustrates a pair of directivity patterns in the yz-plane and the xy-plane for a “scorpion” tail 110, which can be used to efficiently terminate a distal end of a waveguide antenna, such as the waveguide antenna 70 of FIG. 7A, the waveguide antenna 70″ of FIG. 9B, or a waveguide antenna 100 configured from a corrugated and bendable copper conduit having an elliptical cross-section, as shown. And, as highlighted by the graph of FIG. 10B, an almost perfect radiation efficiency can be achieved across a broad frequency range from 24 GHz to 26.5 GHz, by using a radiator tail 110 having a generally concave/underside radiating surface 110a, which faces the same underside radiating direction as the tapered slot arrays 72, and an opposing and generally convex surface 110b, which is integrated into the non-radiating “top” surface of the waveguide antenna 100.

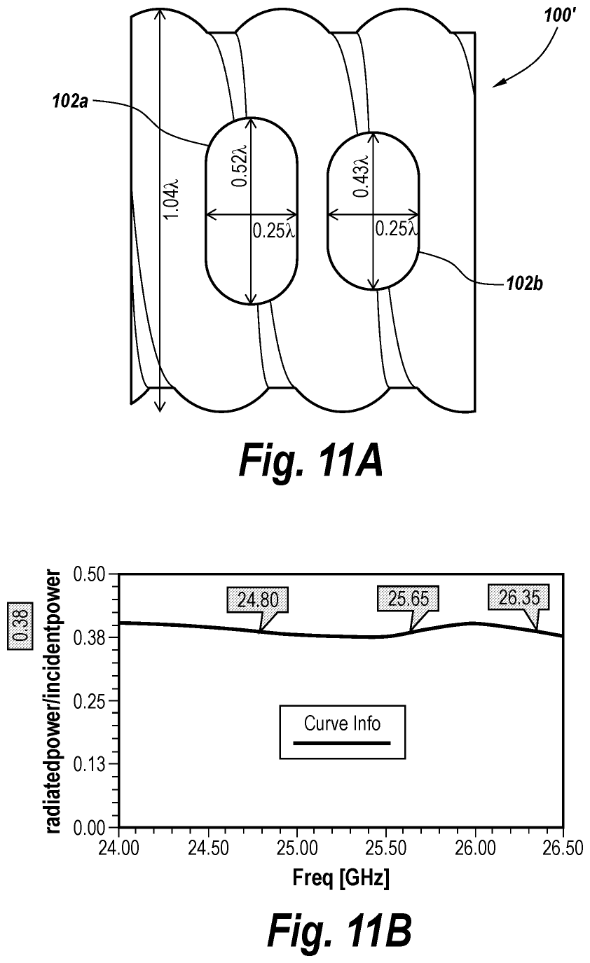

One embodiment of an intermediate radiating portion of the corrugated copper conduit waveguide antenna 100 of FIGS. 10A-10B is illustrated by the leaky waveguide antenna segment 100′ of FIG. 11A, which has a width of 1.04λ. As shown, the antenna segment 100′ includes two slots 102a, 102b of unequal length (0.52λ and 0.43λ), but equivalent width (0.25λ), that implement a generally uniform radiation efficiency of about 38%, across a frequency range from 24 GHz to 26.5 GHz, as highlighted by the graph of FIG. 11B. Although not wishing to be bound by any theory, the choice of slot width can operate as a “Q-factor” tuning method. Accordingly, the widths of the slots in a multi-slot array need not always be tapered, as illustrated by slots 72a-72d of FIG. 7A.

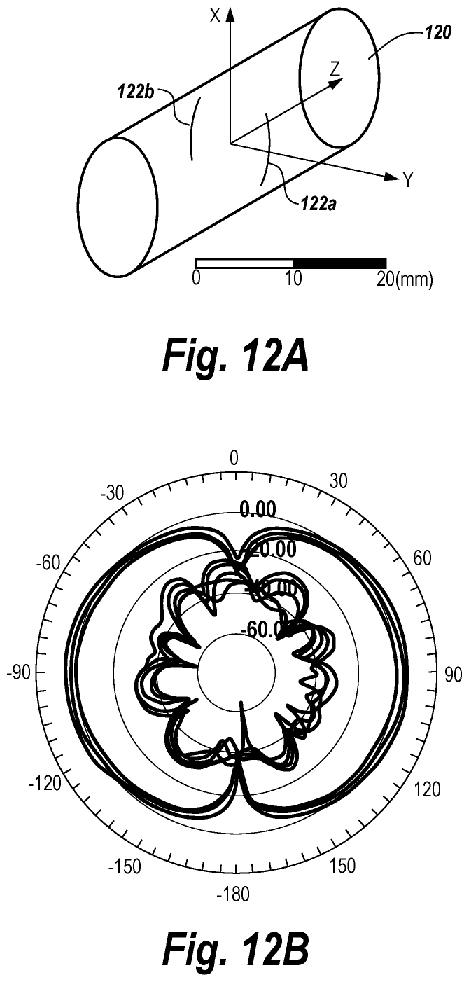

Another embodiment of a leaky waveguide antenna segment 120 may include first and second “mirror-image” slots 122a, 122b on respective first and second opposing sides thereof, as shown by FIG. 12A. In addition, FIG. 12B illustrates a directivity pattern for the waveguide antenna segment of FIG. 12A across a frequency range from 24 GHz to 26.5 GHz. Although not shown, the first slot 122a may be replaced by a tapered array of slots and the second slot 122b may be replaced by a tapered array of slots, as described hereinabove.

In the drawings and specification, there have been disclosed typical preferred embodiments of the invention and, although specific terms are employed, they are used in a generic and descriptive sense only and not for purposes of limitation, the scope of the invention being set forth in the following claims.

1. An antenna, comprising:
an elliptical waveguide having a plurality of length-tapered multi-slot arrays of elongate slots therein at respective spaced-apart locations along a length thereof.

2. The antenna of claim 1, wherein the plurality of length-tapered multi-slot arrays of elongate slots includes at least first and second length-tapered multi-slot arrays of elongate slots, which are spaced apart from each other along the length of said elliptical waveguide; wherein the first length-tapered multi-slot array of elongate slots includes: (i) a first elongate slot having a first length and a first width, and (ii) a second elongate slot having a second length and a second width; and wherein the first length is greater than the second length, but the first width is less than the second width.

3. The antenna of claim 2, wherein the first length-tapered multi-slot array of elongate slots further includes a third elongate slot having a third length and a third width; wherein the second length is greater than the third length, but the second width is less than the third width; and wherein the second elongate slot is between the first elongate slot and the third elongate slot.

4. The antenna of claim 3, wherein a spacing between a center of the third elongate slot and a center of the second elongate slot is greater than a spacing between the center of the second elongate slot and a center of the first elongate slot.

5. The antenna of claim 4, wherein the centers of the first, second and third elongate slots are collinear.

6. The antenna of claim 5, wherein the centers of the first, second and third elongate slots are aligned with a longitudinal axis of said elliptical waveguide.

7. The antenna of claim 4, wherein the first, second and third elongate slots and the spacings therebetween are collectively configured to support first, second and third radio frequency (RF) radiation from the first, second and third elongate slots, respectively, with corresponding first, second and third output phases that deviate from each other by no more than 90°, in response to application of a RF transmission signal adjacent a first end of said elliptical waveguide.

8. (canceled)

9. (canceled)

10. The antenna of claim 4, wherein the first, second and third elongate slots and the spacings therebetween are collectively configured to support first, second and third radio frequency (RF) radiation from the first, second and third elongate slots, respectively, with corresponding first, second and third output phases that deviate from each other by no more than 50°, in response to application of a RF transmission signal adjacent a first end of said elliptical waveguide.

11. The antenna of claim 1, wherein said elliptical waveguide comprises a non-elliptical waveguide tail at a distal end thereof.

12. The antenna of claim 11, wherein the waveguide tail comprises a concave radiation surface thereon.

13.-21. (canceled)

22. An antenna, comprising:
a waveguide having a plurality of length and width-tapered arrays of slots therein, disposed at respective spaced-apart locations along a length of said waveguide; and
a waveguide tail at a distal end of said waveguide.

23. The antenna of claim 22, wherein each of the plurality of length and width-tapered arrays of slots are aligned to a longitudinal axis of said waveguide; wherein centers of the slots within the plurality of length and width-tapered arrays of slots are collinear and aligned along a first side of said waveguide; wherein said waveguide tail has a concave radiation surface thereon; and wherein at least a portion of the concave radiation surface faces the same direction as the first side of said waveguide.

24. The antenna of claim 23, wherein said waveguide tail has a convex surface thereon; and wherein at least a portion of the convex surface faces an opposite direction relative to the first side of said waveguide.

25. The antenna of claim 24, wherein said waveguide comprises corrugated copper.

26. The antenna of claim 25, wherein the corrugated copper has an elliptical cross-section.

27.-38. (canceled)

39. An antenna, comprising:
an elongate waveguide having N spaced-apart radio frequency (RF) radiating nodes X₁ through X_{N} that are distributed along a length thereof in numerical order, with the first node X₁ being the node closest to an RF transmission source, said waveguide configured so that a coupling ratio (C_{N-1}) associated with an X_{N-1} radiating node is within 10% of L_{N}C_{N}/(1+L_{N}C_{N}), where C_{N} is the coupling ratio associated with radiating node X_{N}, L_{N} is the loss factor associated with a segment of said elongate waveguide extending between radiating node X_{N-1} and radiating node X_{N}, and N is a positive integer greater than one.

40. The antenna of claim 39, wherein the coupling ratio C_{N} is equivalent to a ratio of RF power radiated from radiating node X_{N} relative to RF power incident at radiating node X_{N}, when said elongate waveguide is energized to transfer an RF transmission signal from radiating node X_{N-1} to radiating node X_{N}.

41. The antenna of claim 40, wherein the loss factor L_{N} is equivalent to a ratio of the RF power incident radiating node X_{N} relative to RF power incident the segment of said elongate waveguide extending between radiating nodes X_{N-1} and X_{N}, when said elongate waveguide is energized to transfer the RF transmission signal from radiating node X_{N-1} to radiating node X_{N}.

42. The antenna of claim 41, wherein radiating node X_{N} is located at a distal end of said elongate waveguide; and wherein C_{N} is in a range from 0.9 to 1.0.

43. (canceled)

44. The antenna of claim 39, wherein said waveguide is further configured so that a coupling ratio (C_{N-2}) associated with radiating node X_{N-2} is within 10% of L_{N-1}C_{N-1}/(1+L_{N-1}C_{N-1}), where C_{N-1} is the coupling ratio associated with radiating node X_{N-1}, and L_{N-1} is the loss factor associated with a segment of said elongate waveguide extending between radiating node X_{N-2} and radiating node X_{N-1}.

45. (canceled)
